(19) United States
(12) Patent Application Publication
(10) Pub. No.: US 2025/0033098 A1
(43) Pub. Date: Jan. 30, 2025

(54) Process for Rinsing a Coating Product Application Device, and Associated Device

(71) Applicant: Exel Industries, Epernay (FR)

(72) Inventor: Thibault Cognon, Clichy (FR)

(21) Appl. No.: 18/781,867

(22) Filed: Jul. 23, 2024

(30) Foreign Application Priority Data
Jul. 24, 2023 (FR) 2307938

(51) Int. Cl. B08B 9/032; B08B 9/035

(52) U.S. Cl. CPC B08B 9/0325; B08B 9/0328; B08B 9/035; B08B 2209/032

(57) ABSTRACT

The invention relates to a method for rinsing a coating product application device comprising a metering device and a coating product applicator. The metering device comprises a metering pump having an inlet connected to a gas supply channel and a solvent supply channel and an outlet connected to the applicator. Each of the supply channels is provided with a respective valve.

The method comprises at least one step of suction by the metering pump of a volume during at least one suction phase of the metering pump, the valves being alternately in the open configuration during the at least one suction phase, in such a way that the volume sucked in during the at least one suction phase comprises alternately gas and solvent.

The invention further relates to an associated application device.

### CROSS-REFERENCE TO RELATED APPLICATION(S)

This application claims the benefit of FR 2307938 filed on Jul. 24, 2023, which is incorporated herein by reference in its entirety.

### BACKGROUND

The present invention relates to a method for rinsing a coating product application device comprising a metering device, and an associated device.

For rinsing a coating product application device, solvent is e.g. injected into the application device.

However, such a method uses a lot of solvent.

The aim of the invention is then to propose a more ecological method of rinsing a coating product application device.

### SUMMARY

To this end, the invention relates to a method for rinsing a coating product application device comprising a metering device and a coating product applicator, the metering device comprising a metering pump having an inlet and an outlet, the inlet being connected to a gas supply channel and a solvent supply channel, the outlet being connected to the coating product applicator, the gas supply channel being provided with a gas valve, the solvent supply channel being provided with a solvent valve, each of the gas and solvent valves having at least one closed configuration, wherein the valve prevents the passage of gas or solvent, respectively, to the inlet, and at least one open configuration, wherein the valve permits the passage of gas or solvent respectively to the inlet, the method comprising at least one step of suction by the metering pump of a volume during at least one suction phase of the metering pump, the gas valve and the solvent valve being alternately in the open configuration during at least one suction phase, in such a way that the volume sucked in during the at least one suction phase comprises alternately gas and solvent.

Thereby, gas is injected into the solvent. An emulsion is thereby produced, that is used to rinse the application device. As a result, the quantity of solvent used for rinsing, is reduced.

According to other advantageous aspects of the invention, the rinsing method comprises one or a plurality of the following features, taken individually or according to all technically possible combinations:
the at least one suction phase comprises, in the following order, the following steps: opening a first valve among the gas valve and the solvent valve, suction of gas or solvent by the metering pump for a first volume, closing of the first valve, opening of a second valve among the gas valve and the solvent valve, the second valve being different from the first valve, suction of gas or solvent by the metering pump for a second volume, and closing of the second valve, said preceding steps being repeated throughout at least one suction phase;
the suction comprises a suction cycle comprising a gas suction and a solvent suction by the metering pump, said suction cycle being repeated throughout the suction phase;
the metering method comprises a detection of the suction volume during the intake by the metering pump, more particularly by a sensor for the volume sucked in or a displacement sensor of the metering pump;
the metering device further comprises at least two supply channels for the respective component product;
the metering pump is a piston pump;
the gas supply channel is equipped with a compressor, the compressor being suitable for compressing the gas to the inlet of the metering pump upstream of the gas valve, the solvent supply channel being equipped with a secondary solvent pump, the secondary solvent pump being suitable for pumping solvent to the inlet of the metering pump, the secondary solvent pump being arranged upstream of the solvent valve; and/or
the metering device comprises a mixer downstream of the outlet of the metering pump, more particularly arranged adjacent to the outlet of the metering pump.

The invention further relates to a coating product application device comprising a metering device and a coating product applicator, the metering device comprising a metering pump, a gas supply channel and a solvent supply channel, and a control module, the metering pump having an inlet and an outlet, the inlet being connected to the gas supply channel and the solvent supply channel, the outlet being connected to the coating product applicator, the gas supply channel being provided with a gas valve, the solvent supply channel being provided with a solvent valve, each of the gas and solvent valves having at least one closed configuration, wherein the valve prevents the passage of gas or solvent, respectively, to the inlet, and at least one open configuration, wherein the valve permits the passage of gas or solvent, respectively, to the inlet, the control module being apt to control the gas valve and the solvent valve, the control module being configured to implement suction according to the at least one suction step of the process described hereinabove.

### BRIEF DESCRIPTION OF THE DRAWINGS

The invention will be clearer upon reading the following description, given only as an example, but not limited to, and making reference to the drawings wherein:

FIG. 1 is a schematic view of an example of application during rinsing according to a first embodiment of the invention;

FIG. 2 is a schematic view of an example of application during rinsing according to one embodiment of the invention; and

FIG. 3 is an example of metering pump for an application device according to the invention.

### DETAILED DESCRIPTION

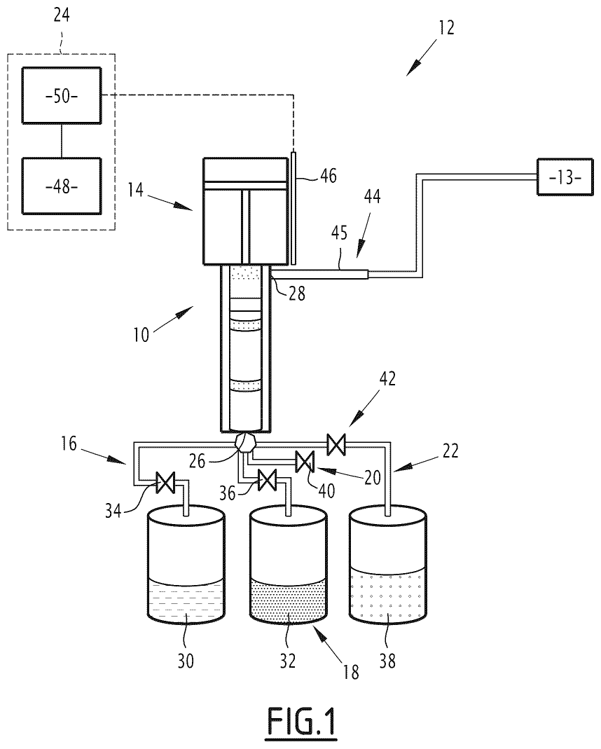

A first example of a coating product application device 12 will now be described with reference to FIG. 1.

The coating product is e.g. a multi-component product.

The coating product is e.g. a paint.

The coating product has e.g. a viscosity comprised between 1100 Cps and 10,000 Cps.

The coating product application device 12 comprises a metering device 10.

The applicator device 12 further comprises a coating product applicator 13.

The applicator 13 is e.g. one or a plurality of spray guns, or one or a plurality of rotary spray bowls, or one or a plurality of deposition valves.

The metering device 10 comprises a metering pump 14.

The metering device 10 herein comprises a gas supply channel 20 and a solvent supply channel 22.

The metering device 10 herein further comprises a plurality of supply channels 16, 18 for the respective component product.

The metering device 10 further comprises herein an electronic device 24.

The metering pump 14 comprises an inlet 26 and an outlet 28.

The metering pump is apt to pump a given volume of fluid, either liquid or gaseous.

The metering pump has e.g. a cylinder capacity comprised between 10 cc and 500 cc.

The metering pump has at least one suction phase.

In one embodiment, the metering pump has a suction phase and a non-suction phase.

During the suction phase, a volume corresponding to the cylinder capacity of the metering pump enters the metering pump at the inlet. In addition, during the suction phase, a volume corresponding to a first portion, herein half, of the cylinder capacity of the pump exits from the pump at the outlet.

During the non-suction phase, no fluid enters the metering pump at the inlet. A volume corresponding to a second portion, supplementary to the first portion, herein half, of the cylinder capacity of the pump exits from the pump at the outlet.

In the example shown, the metering pump 14 is a piston pump.

The piston pump operates with a suction phase and a phase without suction, as described hereinabove.

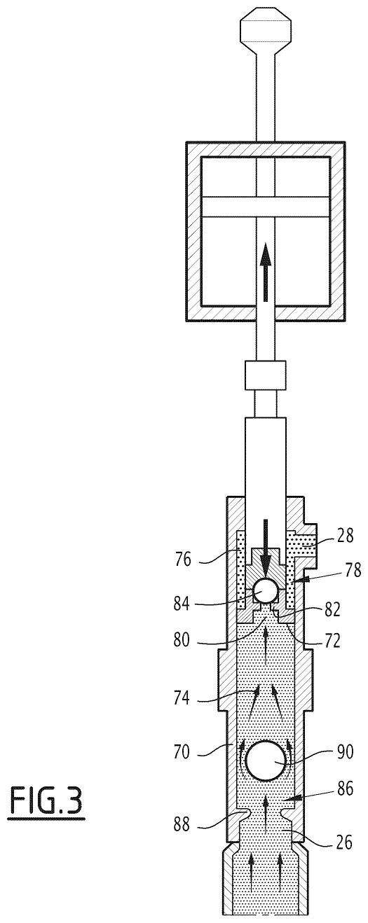

An example of a piston pump used as a metering pump 14 is e.g. shown in FIG. 3 during the suction phase.

The metering pump comprises e.g. a cylinder 70 and a piston head 72, the piston head 72 delimiting two chambers of variable volume in the cylinder, called an upstream chamber 74 and a downstream chamber 76.

The inlet 26 is arranged opposite the outlet 28.

The inlet 26 opens out into the upstream chamber 74 opposite the downstream chamber 76, the outlet 28 opens out into the downstream chamber 76 opposite the upstream chamber 74.

The piston head 72 is, herein, provided with a discharge valve 78.

The piston head delimits an opening 80 for the passage of fluid from the upstream chamber 74 to the downstream chamber 76, the discharge valve 78 preventing the passage of fluid from the downstream chamber 76 to the upstream chamber 74.

The discharge valve 78 comprises e.g. a seat 82 delimited by the head and surrounding the opening and a ball 84 apt to rest on the seat 82.

The piston pump is further provided with a suction valve 86 arranged at the inlet 26 of the metering pump.

The suction valve prevents fluid from leaving the metering pump at the inlet 26.

The suction valve comprises e.g. a seat 88 surrounding the inlet 26 and a ball 90 apt to rest on the seat.

During the suction phase of the metering pump, the piston head 72 moves toward the outlet 28. The volume contained in the downstream chamber 76 is expelled via the outlet 28. Furthermore, a vacuum is created in the upstream chamber 74, and a fluid is sucked in at the inlet 26, more particularly corresponding to the cylinder capacity of the pump.

More particularly, the ball 90 of the suction valve 86 moves away from the seat 88 because of the negative pressure generated in the upstream chamber 74, and the ball 84 [moves away] from the discharge valve 78 resting on the seat 82 because of the overpressure in the downstream chamber.

During the phase without suction of the metering pump, the piston head moves toward the inlet 26. No fluid enters through the inlet 26. The volume contained in the downstream chamber 76 is expelled via the outlet 28. A portion of the volume, herein half the volume, contained in the upstream chamber 74 moves in the downstream chamber 76.

More particularly, the ball 90 of the suction valve 86 rests on the seat 88 because of the overpressure generated in the upstream chamber 74, and the ball 84 of the discharge valve 78 moves away from the seat 82 thereof and releases the opening 80 because of the negative pressure in the downstream chamber 76.

Alternatively, during the suction phase, a volume corresponding to the cylinder capacity of the metering pump enters the metering pump at the inlet, and no fluid exits the pump at the outlet, and during the phase without suction, a volume corresponding to the cylinder capacity of the metering pump exits the pump at the outlet, and no fluid enters the metering pump at the inlet.

Alternatively, the metering pump comprises a piston comprising a head having no opening and defining two non-communicating chambers, including a pumping chamber. The inlet and outlet of the metering pump are arranged in the same pumping chamber. The inlet and the outlet open more particularly into the pumping chamber opposite the other chamber delimited by the head. The inlet and the outlet are e.g. each equipped with a non-return valve. The metering pump then has a suction phase, wherein the pump sucks in a volume of fluid, e.g. equivalent to the cylinder capacity of the pump, and does not expel any fluid, and a phase without suction, wherein the pump expels said volume of fluid.

Alternatively to the piston pump, the metering pump is a diaphragm pump or a ball pump.

The outlet 28 is suitable for being connected to the coating product applicator 13, so that the metering pump 14 feeds the coating product applicator.

The inlet is connected to the gas supply channel 20 and/or the solvent supply channel 22, and further to the respective plurality of component product supply channels 16, 18, where appropriate.

In the example shown, a connector is arranged at the inlet 26.

The connector is e.g. a distribution unit.

The connector is connected to each of the supply channels.

Each component product supply channel 16, 18 is apt to feed the inlet of the metering pump 14 with the corresponding component product, e.g. from a respective tank 30, 32 specific to said supply channel containing the corresponding component product.

The component product supply channels 16, 18 meet e.g. upstream of the inlet at a connection point, the connection point being connected to the inlet.

The connection point is e.g. adjacent to the inlet 26.

Alternatively, each component product supply channel 16, 18 is connected to the inlet 26 separately from one another.

Each component product supply channel 16, 18 is provided with a respective valve 34, 36.

The respective valve 34, 36 is arranged upstream of the inlet 26, more particularly upstream of the connection point, where appropriate.

The respective valve 34, 36 is herein arranged downstream of the respective tank 30, 32.

Each valve 34, 36 has at least one closed configuration, wherein the valve prevents the passage of the corresponding component product through said valve, i.e. herein toward the inlet 26, and at least one open configuration, wherein the valve permits the passage of the corresponding component product through said valve, i.e. herein toward the inlet 26.

Each valve 34, 36 herein has a closed configuration and a plurality of open configurations. The flow rates of the corresponding component product through said valve differ depending on the open configurations.

Alternatively, each valve 34, 36 herein has only a closed configuration and an open configuration.

The flow rate of the corresponding component product in the supply channel is then e.g. adjustable at another location on the supply channel, e.g. with a flow rate control valve, e.g. at the applicator 13 or on the outlet line 44.

The gas supply channel 20 is apt to supply gas to the inlet 26, more particularly air, e.g. compressed air.

The solvent supply channel 22 is apt to supply solvent to the inlet 26, e.g. from a solvent tank 38 containing solvent.

In one embodiment, the solvent supply channel is also considered to be a component supply channel, as described herein above, the multi-component product comprising solvent.

The gas supply channel 20 and the solvent supply channel 22 meet e.g. upstream of the inlet at a connection point, the connection point being connected to the inlet. The connection point is e.g. the same as the connection point of the component product supply channels 16, 18, all the supply channels meeting at said connection point.

Alternatively, each supply channel 16, 18, 20, 22 is connected to the inlet 26 separately from one another.

The gas supply channel 20 is provided with a gas valve 40.

More particularly, in the example shown, the gas valve 40 is arranged at the upstream end of the gas supply channel 20.

The gas valve 40 is e.g. apt to take gas, more particularly air, from the atmosphere surrounding the metering device 10.

The gas valve 40 is arranged upstream of the inlet 26, more particularly upstream of the connection point, where appropriate.

The gas valve 40 has at least one closed configuration, wherein the valve prevents the passage of gas through the valve 40 to the inlet 26, and at least one open configuration, wherein the valve permits the passage of gas through the valve 40 to the inlet 26.

As described hereinabove with respect to the valves 34, 36, the gas valve 40 has e.g. a closed configuration and a plurality of open configurations, or alternatively only a closed configuration and an open configuration.

The solvent supply channel 22 is provided with a solvent valve 42.

The solvent valve 42 is arranged upstream of the inlet 26, more particularly upstream of the connection point, where appropriate.

The solvent valve 42 is herein arranged downstream of the solvent tank 38.

The solvent valve 42 has at least one closed configuration, wherein the valve prevents the passage of solvent through the valve 42 to the inlet, and at least one open configuration, wherein the valve permits the passage of solvent through the valve 42 to the inlet 26.

As described hereinabove with respect to the valves 34, 36, the solvent valve 42 has e.g. a closed configuration and a plurality of open configurations, or alternatively only a closed configuration and an open configuration.

The application device 12 further comprises an outlet line 44.

The outlet line 44 extends herein between an upstream end and a downstream end.

The outlet line 44, more particularly the upstream end, is connected to the outlet 28 of the metering pump 14.

The downstream end is connected to the applicator 13.

More particularly, the metering pump 14 expels the product contained in the metering pump into the outlet line 44.

The metering device 10 further comprises a mixer 45, herein a mechanical mixer, more particularly a static mixer, downstream of the outlet 28 of the metering pump, more particularly arranged adjacent to the outlet 28 of the metering pump.

The mixer 45 is herein arranged in the outlet line 44, more particularly at the upstream end of the outlet line 44.

The metering device 10 is further provided herein with a sensor 46 for the volume entering the metering pump 14 or a sensor for the displacement of the metering pump 14.

In the example shown, the sensor 46 is apt to and arranged to measure the displacement of the piston of the metering pump 14.

Alternatively, the sensor 46 is apt to detect a parameter relating to the metering pump, said parameter depending directly on the volume entering the metering pump 14.

For example, in the case of a pump with a notched gear, the sensor is e.g. apt to detect the notch of the engaged gear.

Additionally or alternatively, the sensor 46 is arranged at the inlet 26 and measures the volume of fluid entering the metering pump 14 via the inlet 26.

The sensor 46 provides e.g. an analog signal, e.g. the incoming volume or the displacement of the piston.

Alternatively, the sensor 46 provides a digital signal, e.g. a notch of a gear or corresponding to a threshold of displacement of the piston or of incoming volume.

The electronic device 24 comprises an information processing unit consisting e.g. of a memory and of a processor associated with the memory.

The electronic device 24 comprises a control unit 48.

The control module 48 is apt to control the respective valves 34, 36 of the supply channels, more particularly as described thereafter.

The control module 48 is e.g. connected to the valves 34, 36, e.g. by wire or by a remote connection.

The control module 48 is further apt to control the gas valve 40 and the solvent valve 42, where appropriate.

The control module 48 is e.g. connected to the valves 40, 42, e.g. by wire or by a remote connection.

The response time for each of the valves 34, 36, 40, 42 from the command of the control module 48 is comprised between 100 and 250 milliseconds.

The control module 48 is configured to implement the suction as described in the metering method described thereafter.

The control device 24 further comprises a monitoring module 50.

The monitoring module 50 is connected to the control module 48.

The monitoring module 50 is further connected to the sensor 46, e.g. by wire or by a remote connection.

More particularly, the monitoring module 50 is suitable for receiving information from the sensor 46, more particularly the signal supplied by the sensor 46 comprising the measurements made by the sensor 46.

The monitoring module 50 is apt to determine the quantity of volume entering the metering pump 14 and the nature of the fluid entering the pump 14, depending upon the configuration of each of the valves.

The monitoring module 50 is then apt to determine the quantity of each fluid entering the metering pump 14 successively.

The control module 48 and, where appropriate, the monitoring module 50 are each produced in the form of a software, or a software brick which can be executed by the processor. The memory of the electronic device is then apt to store a control software and a monitoring software. The processor is then apt to execute each of the software programs among the control software and the monitoring software.

In a variant (not shown), the control module 48 and, where appropriate, the monitoring module 50 are each produced in the form a programmable logic component, such as an FPGA (Field Programmable Gate Array), or else of an integrated circuit, such as an ASIC (Application Specific Integrated Circuit).

When the electronic device is produced in the form of one or a plurality of software programs, i.e. in the form of a computer program, same is further apt of being recorded on a computer-readable medium (not shown). The computer-readable medium is e.g. a medium apt to store the electronic instructions and to be coupled to a bus of a computer system. As an example, the readable medium is an optical disk, a magneto-optical disk, a ROM, a RAM, any type of non-volatile memory (e.g. FLASH or NVRAM) or a magnetic card. A computer program containing software instructions is then stored on the readable medium.

In the example shown in FIG. 1, the fluid is sucked in by the metering pump 14 during the suction phase by a so-called passive suction, i.e. during the suction phase, the metering pump 14 creates a negative pressure at the inlet 26 thereof, which attracts a fluid, more particularly the fluid(s) coming from a channel the corresponding valve of which is in the open configuration.

Such a device is particularly simple.

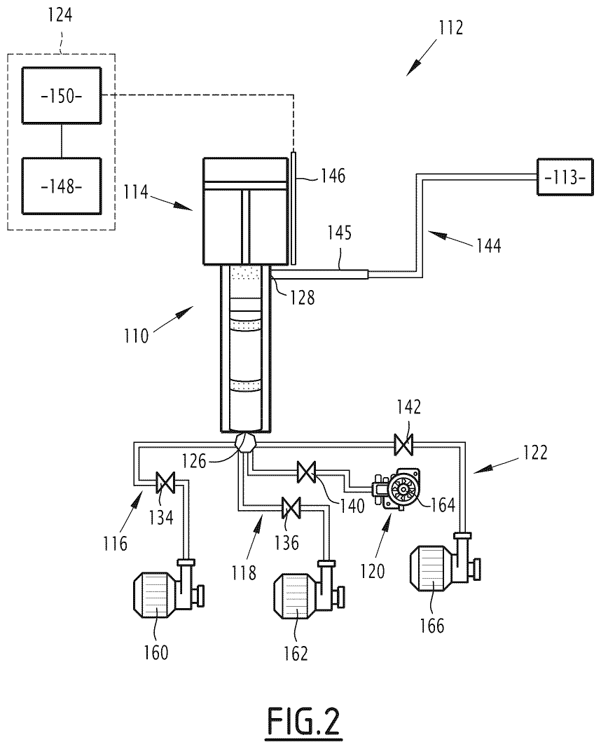

A second example of application 112 of a coating product for application according to a second embodiment of the invention will now be described with reference to FIG. 2.

Only the features by which the second embodiment differs from the first embodiment will be described hereinafter in the description. With the exception of such features, the application device 112 is also identical to the first example of an application device.

Identical or similar elements have the same number reference incremented by 100.

In the second embodiment, the gas supply channel 120 is provided with a compressor 164, the compressor 164 being suitable for compressing the gas toward the inlet 126 of the metering pump 114.

The compressor 164 is arranged upstream of the gas valve 140.

The compressor 164 is, more particularly, apt to take gas, more particularly air, from the atmosphere surrounding same, and to compress said gas in the gas supply channel 120 upstream of the gas valve 140.

The solvent supply channel 122 is provided with a secondary solvent pump 166, the secondary solvent pump 166 being adapted to pump the solvent to the inlet 126 of the metering pump 114.

The secondary solvent pump 166 is arranged upstream of the solvent valve 142.

The secondary solvent pump 166 is e.g. arranged downstream of a solvent tank (not shown).

Furthermore, each component product supply channel 116, 118 comprises a respective secondary pump 160, 162, the respective secondary pump 160, 162 being suitable for pumping the respective component product toward the inlet 126 of the metering pump 114.

Each respective secondary pump 160, 162 is arranged upstream of the respective valve 134, 136 of the supply channel 116, 118.

Each respective secondary pump 160, 162 is e.g. arranged downstream of a respective tank (not shown).

In the example shown in FIG. 2, the fluid is sucked in, during the suction phase, by the metering pump 114 by a so-called active suction, i.e. the fluid is pushed toward the inlet 126 by the corresponding secondary pump or the compressor. During the suction phase, the metering pump 114 then sucks in the pushed fluid, more particularly the fluid or fluids coming from a channel the corresponding valve of which is in the open configuration.

Such an applicator device 12; 112 is apt to coat a coating product dosed by the metering device 10; 110, more particularly by expulsion of the coating product at the applicator 13; 113.

More particularly, the metering device 12; 112 is apt to meter the different component products to form a single or multi-component product, preferably a multi-component product, more particularly herein by selectively moving the valves 34, 36; 134, 136 in an open configuration during the suction phase of the metering pump 14; 114 depending on the component product to be taken to form the multi-component product.

The metering is e.g. implemented and controlled by the electronic device 24; 124.

The multi-component product is e.g. premixed by moving the piston head, in the example of a pump described with reference to FIG. 3.

The multi-component product is e.g. mixed by the mixer 45; 145 on the outlet line 44; 144.

Then, the single- or multi-component product, preferably multi-component, forming the coating product, is expelled by the applicator 13; 113, more particularly toward a surface to be coated.

Following the application step, multi-component product is thus present in the application device 12; 112. The application device 12; 112 is then e.g. rinsed.

A rinsing method for a coating product application device as described hereinabove, will now be described.

The rinsing method comprises a step of suction by the metering pump of one volume during a suction phase of the metering pump, the gas valve and the solvent valve being alternately, one after the other, in the open configuration during suction, in such a way that the volume sucked in during said suction phase alternately comprises gas and solvent.

More particularly, the rinsing method comprises such a suction step during each of the suction phases of the metering pump 14, 114, throughout the duration of the rinsing.

The control module 48, 148 implements the suction step through a successive control of the valves, more particularly the gas valve and the solvent valve.

The minimum sucked-in volume of solvent during a valve opening is e.g. greater than or equal to 0.5 cubic centimeter, more particularly greater than or equal to 1 cubic centimeter, more particularly comprised between 1 and 100 cubic centimeters.

The maximum volume of solvent sucked in during a valve opening is e.g. less than or equal to 1000 cubic centimeter, more particularly between 300 and 1000 cubic centimeter.

The gas valve 40; 140 is e.g. moved to the open configuration for a duration comprised between 1 pump cycles and 100 pump cycles, more particularly between 4 and 10 cycles.

At any time, at most one valve of the gas or solvent supply channels is open at a time.

Specifically, suction comprises, in the following order, the following steps:
opening of a first valve among the gas valve and the solvent valve;
suction of a first volume of gas or solvent by the metering pump;
closing of the first valve;
opening of a second valve between the gas valve and the solvent valve, the second valve being different from the first valve;
suction of a second volume of gas or solvent; and
closing of the second valve,
   said preceding steps being repeated throughout the suction phase of the metering pump 14; 114.

The first volume remains the same throughout the suction phase, more particularly during all the suction phases of the rinsing.

The second volume remains the same throughout the suction phase, more particularly during all the suction phases of the rinsing.

The suction has, more particularly herein, a suction cycle comprising a gas suction and a solvent suction by the metering pump, said suction cycle being repeated throughout the suction phase, more particularly during all the suction phases of the rinsing.

If at the end of a suction phase a suction cycle is in progress, the suction cycle will resume where same stopped, during the following suction phase.

For example, for a suction volume of the pump of 100 cc, if the volume of solvent to be sucked in is 32 cc and of air is 55 cc, then, during the first suction phase, the volume is e.g. sucked in successively: 32 cc solvent, 55 cc air, then only 13 cc of solvent. Thereby, the second suction phase begins with the suction of 19 cc of solvent, then 55 cc of air, then 26 cc of solvent, and so on for the subsequent suction phases.

Herein, the volume sucked in by the metering pump 14, 114 during each of the suction phases thereof comprises an alternation of solvent and gas, which is repeated along the sucked in volume.

Alternatively, the volume of solvent and/or air to be sucked in is greater than or equal to the suction volume of the pump. Where appropriate, the volume sucked in by the metering pump 14, 114 during a suction phase may comprise only solvent or gas. However, the volume sucked by the metering pump 14, 114 during all the suction phases thereof comprises an alternation of solvent and gas, which is repeated along the sucked volume.

For example, with a suction volume of the pump of 25 cc, if the volume of solvent to be sucked in is 78 cc and [the volume] of air is 105 cc, then a plurality of suction phases follow one another to pump the right volume of air on the one hand and solvent on the other.

The rinsing method advantageously comprises a detection of the volume sucked in during suction by the metering pump, more particularly by the sensor 46; 146.

In the first embodiment, the detection of the volume of gas, herein air, sucked in, is directly implemented at the metering pump.

In the second embodiment, the detection of the volume of compressed gas, herein air, entering the metering pump is e.g. carried out at the compressor 164 by activating the compressor 164 for a given period of time. Additionally or alternatively, the detection of the volume of compressed gas, herein air, entering the metering pump is implemented directly at the metering pump.

During suction, when solvent is sucked in by the metering pump 14, 114, when the quantity of solvent sucked in monitored by the monitoring module 50, 150 reaches the desired quantity, then the control module 48, 148 sends an instruction to the solvent valve to switch to the closed configuration, and then sends an instruction to the gas valve to switch to the open configuration.

Then e.g. when the quantity of sucked gas monitored by the monitoring module 50, 150 reaches the desired quantity, more particularly in the first embodiment, then the control module 48, 148 sends an instruction to the gas valve to switch to the closed configuration, then sends an instruction to the solvent valve to switch to the open configuration, and so on.

Alternatively, in the second embodiment, when the gas valve 140 and the compressor 164, respectively, have remained open and activated for a given period of time, then the control module 48, 148 sends an instruction to the gas valve to switch to the closed configuration, then sends an instruction to the solvent valve to switch to the open configuration, and so on.

In the example described, during suction, the metering pump 14, 114 also expels a portion, herein half the cylinder capacity of the metering pump, of fluid at the outlet 28.

Said fluid comprises solvent and gas, herein air, e.g. compressed air.

The fluid is e.g. premixed by the displacement of the piston head, in the example of pump described with reference to FIG. 3.

The fluid is e.g. mixed by the mixer 45; 145 on the outlet line 44; 144.

An emulsion is produced.

The emulsion flows along the outlet line 44; 144 to the applicator 13; 113.

The applicator 13; 113 is thereby also rinsed with the emulsion.

When the metering pump comprises a suction phase and a phase without suction, during the phase without suction, all valves are e.g. in the closed configuration.

Alternatively, if during the suction phase, the volume to be sucked in of the last fluid being sucked in is not reached, then the corresponding valve remains in the open configuration during the phase without suction and will be closed during a next suction phase when the volume to be sucked in is reached.

Thereby, the rinsing method comprises alternately a suction step and a step without suction.

During the step without suction, in the example described hereinabove, the metering pump expels a supplementary portion of the portion expelled during suction, herein half the cylinder capacity of the metering pump, of fluid at the outlet 28.

As before, said fluid comprises solvent and gas, herein air, e.g. compressed air.

The fluid is e.g. premixed by the displacement of the piston head, in the example of pump described with reference to FIG. 3.

The fluid is e.g. mixed by the mixer 45; 145 on the outlet line 44; 144.

An emulsion is produced.

The emulsion flows along the outlet line 44; 144 to the applicator 13; 113.

The applicator 13; 113 is thereby also rinsed with the emulsion.

This rinsing method is implemented directly by the electronic device 24; 124 of the application device 12; 112.

More particularly, the control module 48; 148 implements the suction through a successive control of the gas valve 40; 140 and of the solvent valve 42; 142.

Advantageously, the monitoring module 50; 150 enables the quantity (in volume and/or time) of solvent and gas sucked in by the metering pump 14; 114 to be monitored.

The rinsing can thus be carried out without any human intervention.

Furthermore, alternating solvent and gas in the inlet volume of the metering pump, produces an emulsion that is used for rinsing the application device. As a result, the quantity of solvent used for rinsing, is reduced.

1. A method for rinsing a coating product application device comprising a metering device and a coating product applicator, the metering device comprising a metering pump having an inlet and an outlet, the inlet being connected to a gas supply channel and a solvent supply channel, the outlet being connected to the coating product applicator, the gas supply channel being provided with a gas valve, the solvent supply channel being provided with a solvent valve, each of the gas and solvent valves having at least one closed configuration, wherein the valve prevents the passage of gas or solvent, respectively, to the inlet, and at least one open configuration, wherein the valve permits the passage of gas or solvent, respectively, to the inlet, the method comprising at least one step of suction by the metering pump of a volume during at least one suction phase of the metering pump, the gas valve and the solvent valve being alternately in the open configuration during the at least one suction phase, so that the volume sucked in during the at least one suction phase comprises alternately gas and solvent,
the method comprising a detection of the volume sucked in during the suction by the metering pump, during suction, when solvent is sucked in by the metering pump, when the quantity of solvent sucked in monitored by a monitoring module reaches the desired quantity, then a control module sends an instruction to the solvent valve to switch to the closed configuration, then sends an instruction to the gas valve to switch to the open configuration, and then, when the quantity of sucked gas monitored by the monitoring module reaches the desired quantity, then the control module sends an instruction to the gas valve to switch to the closed configuration, then sends an instruction to the solvent valve to switch to the open configuration, and so on.

2. The rinsing method according to claim 1, wherein the at least one suction step comprises, in the following order, the following steps: opening a first valve among the gas valve and the solvent valve, suction of gas or solvent by the metering pump for a first volume, closing of the first valve, opening of a second valve among the gas valve and the solvent valve, the second valve being different from the first valve, suction of gas or solvent by the metering pump for a second volume, and closing of the second valve, said preceding steps being repeated throughout at least one suction phase.

3. The rinsing method according to claim 1, wherein the suction comprises a suction cycle comprising a suction of gas and a suction of solvent by the metering pump, said suction cycle being repeated throughout the suction phase.

4. The rinsing method according to claim 1, wherein the volume sucked in during the suction by the metering pump is detected by a sensor for the sucked-in volume or a sensor for the displacement of the metering pump.

5. The rinsing method according to claim 1, wherein the metering device further comprises at least two supply channels of the respective component product.

6. The rinsing method according to claim 1, wherein the metering pump is a piston pump.

7. The rinsing method according to claim 1, wherein the gas supply channel is provided with a compressor, the compressor being suitable for compressing the gas to the inlet of the metering pump upstream of the gas valve, the solvent supply channel being provided with a secondary solvent pump, the secondary solvent pump being suitable for pumping solvent to the inlet of the metering pump, the secondary solvent pump being arranged upstream of the solvent valve.

8. The rinsing method according to claim 1, wherein the metering device comprises a mixer downstream of the outlet of the metering pump.

9. The rinsing method according to claim 8, wherein the mixer is arranged adjacent to the outlet of the metering pump.

10. A coating product application device comprising a metering device and a coating product applicator, the metering device comprising a metering pump, a gas supply channel and a solvent supply channel, and a control module, the metering pump having an inlet and an outlet, the inlet being connected to the gas supply channel and the solvent supply channel, the outlet being connected to the coating product applicator, the gas supply channel being provided with a gas valve, the solvent supply channel being provided with a solvent valve, each of the gas and solvent valves having at least one closed configuration, wherein the valve prevents the passage of gas or solvent, respectively, to the inlet, and at least one open configuration, wherein the valve permits the passage of gas or solvent, respectively, to the inlet, the control module being apt to control the gas valve and the solvent valve, the quantity of solvent sucked in and the quantity of gas sucked in being monitored by a monitoring module, the control module and the monitoring module being configured to implement suction according to the at least one suction step of the method according to claim 1.
